(19) United States
(12) Patent Application Publication
(10) Pub. No.: US 2020/0324226 A1
(43) Pub. Date: Oct. 15, 2020

(54) CHEMICAL-FREE FOAM ABATEMENT SYSTEM AND METHOD EMPLOYING MUTUALLY OPPOSED FLUID DIFFUSERS

(71) Applicant: CHEMFREE DEFOAM LLC, Jefferson, GA (US)

(72) Inventor: William Lewis Emkey, Stow, MA (US)

(73) Assignee: CHEMFREE DEFOAM LLC, JEFFERSON, GA (US)

(21) Appl. No.: 16/822,215

(22) Filed: Mar. 18, 2020

Related U.S. Application Data
(63) Continuation of application No. PCT/US2018/051685, filed on Sep. 19, 2018.
(60) Provisional application No. 62/560,853, filed on Sep. 20, 2017.

(51) Int. Cl. B01D 19/02; B05B 1/02; B05B 9/03; C02F 1/68

(52) U.S. Cl. CPC B01D 19/02; B05B 1/02; C02F 2103/28; C02F 1/686; B05B 9/035

(57) ABSTRACT

A method of subsiding foam undesirably accumulating on a liquid-surface plane of an associated industrial-process liquid includes designating a foam-depletion zone within which the foam is situated. A set of at least two fluid ejectors is arranged above and peripherally of foam within the foam-depletion zone, from each of which fluid ejectors a foam-subsiding fluid can be selectively ejected under pressure in a spray pattern representable by a spray vector. Each fluid ejector is oriented such that the spray vector associated therewith has a non-zero vertical component of spatial extension directed downwardly toward the liquid-surface plane and a non-zero horizontal component of spatial extension directed (a) parallel to the liquid-surface plane and (b) inwardly toward the foam-depletion zone so that, collectively, spray patterns emanating from the fluid ejectors constrain the foam within the foam-depletion zone for sustained impingement and abatement by the spray patterns.

### CROSS-REFERENCE TO RELATED APPLICATIONS/PRIORITY CLAIMS

The present application is a continuation application of International Application Serial No. PCT/US2018/051685 filed Sep. 19, 2018 pursuant to the Patent Cooperation Treaty, and under the title “CHEMICAL-FREE FOAM ABATEMENT SYSTEM AND METHOD EMPLOYING MUTUALLY OPPOSED FLUID DIFFUSERS.” Application PCT/US2018/051685 claimed priority benefits in U.S. Provisional Application No. 62/560,853 filed Sep. 20, 2017 under the title “CHEMICAL-FREE FOAM ABATEMENT SYSTEM AND METHOD EMPLOYING MUTUALLY OPPOSED FLUID DIFFUSERS.”

The present application claims the benefit of the filing date of Provisional Application Ser. No. 62/560,853, as well as the filing date of PCT Application No. PCT/US2018/051685, based on the priority chain outlined above. Moreover, the entireties of the disclosures, including the drawings, of both previous applications in the aforesaid priority chain are incorporated herein by reference as if set forth fully in the present application.

### BACKGROUND

Various industries, including the paper and pulp industries and food processing industries by way of non-limiting example, involve the generation of undesirable foam within and on the processing line. Left uncontrolled, this foam can accumulate uncontrollably and eventually shut down a processing line. A typical industry solution involves the addition of chemical de-foaming or anti-foaming agents to a liquid (e.g., water) associated with the industrial process in question. Although chemical additives have proven effective in controlling unwanted foam accumulation, effective non-chemical methods and solutions have been sought. Two reasons for avoiding chemical additives are cost and safety. Safety is a particular concern in industrial food processing settings because measures must be taken to ensure that levels of chemicals coming in contact with the food and remaining thereon after processing are acceptably low.

Typically, the composition of built-up foam transitions from a ‘wet foam’ at the bottom of the foam (small bubble structure with water-like flowability) to a ‘dry foam’ at the surface (large bubbles that adhere to all surfaces and resist flow). Once a significant foam build-up has accumulated, most of the foam volume consists of the drier foam. Several non-chemical approaches for foam control have been evaluated over the years. Some are currently utilized to a limited degree, but primarily to selectively augment chemical additives. There are primarily three basic non-chemical approaches for foam control: (1) water spray, (2) optical, and (3) centrifugal, each of which is briefly described in turn.

Downwardly-directed vertical water sprays are sometimes used to partially “knock down” the foam by spraying the top-surface dry foam to condense it from dry foam to wet foam and thereby reduce the total volume. Large foam-control spray systems are sometimes used in waste treatment and aquaculture farms. The use of water-spray foam control is confined primarily to localized trouble areas, where, due to a combination of physical layout and/or turbulent water flow, foam generation is rapid. These local sprays can be limitedly effective; however, in many cases, these sprays, while reducing the foam volume at the point of impact, can create holes in the foam while pushing foam into the periphery of the spray impact area where it continues to grow. Even the condensed ‘wet foam’ can continue to grow unacceptably within the spray impact area, thus minimizing any further reduction in foam volume. The use of a sprays in these localized ‘hot spots’ does not address the foam problem on the entire production line where, due to the continuous agitation throughout a facility, the foam builds within vessels, channels, and tanks, for example.

Optical solutions for controlling foam have been proposed and selectively tested. In one such system, a high power laser is used to destroy foam. These lasers emit light at or near a wavelength at which the liquid has a strong absorption line. It is believed that the optical absorption by the liquid locally heats the surface of a bubble and causes its destruction. One implementation of this approach includes a CO₂ laser mounted directly over a tank into which foam flows, and where additional foam is also generated due to turbulence within the tank. The laser beam ‘writes’ a line across the foam in a continuously varying pattern. The line defines a region in which the foam is destroyed and the underlying surface water is exposed. Rapid writing of the laser beam reduces the foam volume in those regions and further inhibits foam growth because it provides a localized “non-foamed” region which the surrounding foam fills, thus reducing the rate of foam growth in surrounding regions of the tank. Cost is a primary factor restricting the commercial deployment of such systems. The combination of the systems' capital costs and their operating costs, especially for deployment on a distributed processing line, is widely considered prohibitive.

Centrifugal systems have been used successfully for many years in a variety of industries and applications for separating the constituent liquids and gases of mixtures consisting of liquids and gases. Centrifugal gas/liquid separators typically rotate the liquid itself creating a cyclone or vortex within the liquid. As the “mixed medium” is rotated, the higher-density liquid is driven to the outside leaving behind on the inside the less dense gas, which can be subsequently removed.

Since foam is a gas/liquid mixture of, for example, air and water, a centrifugal gas/liquid separator can be a reasonable approach for non-chemical de-foaming. Consequently, variations of this technology have been studied and have resulted in designs, patents, and products directed at de-foaming applications. For the most part, air/gas separators are complicated systems, all of which require some subset of not only the means for high speed water rotation, but also vacuum systems, pumps, multi-stage impellers, filtering systems, and even heat. These systems do not lend themselves to in-situ foam control, but are best operated as an off-line system where the foamy solution needs to be pulled from all the key areas of the product-flow line into the separator(s), filtered, de-foamed, and then carefully pumped back into the line so as not to generate additional foam. Thus, the current separators manifest themselves as additional stand-alone closed operating systems. The costs associated with these systems are high and include capital cost, installation, maintenance, and floor space.

Other de-foaming technologies exist, but for very specialized applications, such as the aeration/separation systems used in aqua/fish farming. Similar to the application mismatches described above, these are large systems utilizing aeration, pumping, and evacuation techniques. Ultrasonic solutions have also been proposed, and have found specialized applications, such as in canning operations, but have similarly proved not to be a good general fit for broad applications.

To address the aforementioned problems, the sole inventor named in the present application devised a chemical-free foam control system that is now the subject of U.S. Pat. No. 9,713,779, granted Jul. 25, 2017 (hereinafter, the “779 patent”). As successful as that solution has proven in practical implementations, it is also characterized by certain limitations under certain conditions. The limitations of certain “real-world” implementations of the system of the 779 patent lead to innovation of the present system and method.

Like the invention of the 779 patent, the present system builds upon the need for a cost effective, chemical-free foam control system and method that lends itself to broad implementation across various industries challenged by undesirable foam generation. Moreover, like the system of the 779 patent, fluid-spray sources (e.g., “nozzles” or “diffusers”) are implemented in accordance with the present invention. However, the chief principles upon with the two systems operate are mutually distinct. In order to facilitate an appreciation for how the solutions of the 779 patent and the present invention differ, a summary of key operative parameters and conditions of the 779 system are provided as part of the background of the present application.

### Operational Summary of the System Covered by the '779 Patent

As explained in the summary of the 779 patent, in each of various implementations of that invention, there is established a foam-displacement path along which foam resulting from a relevant industrial process is to be moved. Also established is a direction along the foam-displacement path in which resultant foam is to be displaced as the foam accumulates on the surface of the liquid associated with the industrial process. In various industrial processes, the “liquid associated with the industrial process” as defined above, and in the claims appended hereto, will comprise water. In still more particular implementations, the liquid associated with the industrial process lacks chemical defoaming additives such as those presently employed and described in the background section of the specification.

A set of fluid-spray sources is provided including at least first and second fluid-spray sources from each of which a foam-subsiding fluid can be selectively ejected under pressure. In a typical implementation, the set of fluid-spray sources will include many more than two fluid-spray sources, but the inventive concept covered by the 779 patent is sufficiently broad to include implementations employing only first and second fluid-spray sources. Moreover, in practice, each fluid-spray source will comprise at least one spray nozzle.

A key aspect of the inventive system described and claimed in the 779 patent is that the fluid-spray sources (e.g., spray nozzles) are serially arranged above the surface of the liquid associated with the industrial process. In the potato washing context, for example, this will mean the fluid-spray sources are arranged above the wash table, which includes a reservoir of water that serves as the “liquid associated with the industrial process.” Each fluid-spray source is configured such that foam-subsiding fluid ejected therefrom is sprayed in a spray pattern that is centered about a spray axis. Additionally, each spray pattern, regardless of its general configuration (e.g., planar or conical) is representable by a spray vector extending along the spray axis. Each fluid-spray source is oriented such that its associated spray vector has (i) a non-zero component of spatial extension directed perpendicularly to, and downwardly toward, the liquid associated with the industrial process and (ii) a non-zero component of spatial extension directed parallel to the surface of the liquid associated with the industrial process and in the foam-displacement direction. The serial arrangement of the fluid-spray sources defines the foam displacement path.

When a system of the 779 patent is in use, foam-subsiding fluid is ejected from the fluid-spray sources such that foam impacted by foam-subsiding fluid ejected from the first fluid-spray source is wetted, partially subsided, and displaced in the foam-displacement direction toward the spray being ejected from the second fluid-spray source by which the foam is further wetted, subsided and displaced in the foam-displacement direction. Where the system implements three or more fluid-spray sources, foam initially displaced by the first fluid-spray source is displaced toward, under, then through the spray pattern associated with each successive fluid-spray source along the foam-displacement path, each time being further wetted, subsided and displaced. The result is that the foam volume is reduced in increments as the foam is displaced long the foam-displacement path.

In the inventive method of the 779 patent, foam reduction is tied to movement of accumulated foam along a defined foam-displacement path over the surface of an is underlying industrial-process liquid on which the foam is floating. The foam-displacement path typically has discernable starting and ending points, even in implementations in which the foam-displacement path is cyclic. While foam reduction is successive as the foam is moved sequentially between and through fluid-spray sources serially arranged along—and defining—the foam-displacement path, there are cases in which not all of the foam that has been generated is completely subsided before the final set of fluid-spray sources along the foam-displacement path is reached. This may especially be the case in systems characterized by non-cyclic foam-displacement paths, as defined in the 779 patent. The result, especially in systems lacking one or more drains through which residual foam can exit, is that foam reaching the end of a non-cyclic path can eventually accumulate undesirably in “dead zones.”

Accordingly, a need exists for further subsiding residual foam left unabated by systems configured in accordance with the invention of the 779 patent. In various implementations, it is envisioned that a system configured for further subsiding residual foam be implemented in conjunction with a system configured to move foam in sequential increments along a foam-displacement path in the general manner described and claimed in the 779 patent.

### SUMMARY

Like the foam control system and method of U.S. Pat. No. 9,713,779, various alternative implementations of a foam control system (alternatively, “foam abatement system”) and method within the scope of the present invention have in common the objective of subsiding foam resulting from an industrial process. However, whereas the system of the 779 patent relies upon, and actively induces in its various implementations, movement of the undesired process-resultant foam along the surface of the underlying industrial-process liquid (e.g., water) on which the foam is floating, the present system and method is configured to “trap” the foam to be subsided within a foam-depletion zone and minimize the movement of the foam undergoing depletion with respect to the underlying industrial-process fluid.

By way of non-limiting example, implementations are suited for use in industrial processes involving the washing of starchy or pulpy materials (e.g., paper, agricultural produce, etc.) which, when washed and/or churned in a reservoir of liquid associated with the industrial process, yield foam that accumulates on the liquid. One example of a process for which implementations of the method and system is particularly well-suited involves the preparation of potatoes for the making of potato chips and, more particularly, the washing of potato slices in a wash table before the potato slices are conveyed out of the wash table for subsequent processing (e.g., cooking). While some implementations of the system and method are explained and described in the context of potato processing in both the summary and detailed description, it is to be understood that the invention as defined in the appended claims is not so limited, except to the extent that particular claims are expressly so limited by their own terminology. On the contrary, explicitly within the scope and contemplation of the overall inventive concept is its configuration for, and application within, nearly any process resulting in the production and accumulation of undesirable foam on the surface of an associated, underlying industrial-process liquid, which liquid will frequently include water.

By way of establishing an illustrative environment, each of various implementations is envisioned as a method of subsiding foam resulting from an industrial process and accumulating on the surface of an industrial-process liquid associated with that industrial process along a horizontal liquid-surface plane corresponding to the surface of the industrial-process liquid. Throughout the specification and claims, the term “horizontal,” as in “horizontal plane,” is used in the sense ordinarily understood, and with reference to the earth's gravitational field. That is, if the weight force of an object on earth is represented by a vector “downwardly directed” toward earth's center, then a horizontal plane is one that is orthogonal to this wright-force vector. Additionally, terms such as “vertical,” “above,” “below,” and “downwardly,” and derivatives and synonyms thereof, are used in a similar sense.

Importantly, implementations of the method include designating a foam-depletion zone within which residual foam resulting from the industrial process is situated. The foam-depletion zone has defined in association therewith a depletion-zone perimeter and, inwardly of the depletion-zone perimeter, a depletion-zone center region that, in various implementations, includes a geometric center of the foam-depletion zone.

A set of fluid ejectors is provided that, at least in their individual configurations, but not in their mutual arrangement and alignment, may generally correspond to the fluid-spray sources of the 779 patent. In any event, like the fluid-spray sources of the 779 patent, each fluid ejector is configured to selectively eject a foam-subsiding fluid under pressure in a spray pattern that is representable by a spray vector. Moreover, the spray pattern is typically centered about a spray axis along which the spray vector extends.

While some system configurations within the scope and contemplation of the invention employ as few as two fluid-ejectors working “in opposition” to one another, initial discussion of an implementation employing a plurality of at least three fluid ejectors facilitates conceptualization, and is also more representative of a “real world application.” The fluid ejectors are peripherally disposed above the liquid-surface plane and about the depletion-zone perimeter. In this way, the fluid ejectors are above residual foam that is situated within the bounds of the depletion-zone perimeter and on the surface of the liquid associated with the industrial process (a.k.a., the industrial-process liquid).

In addition to their peripheral disposition, the fluid ejectors are mutually arranged so that they are inwardly and downwardly directed toward the depletion-zone center region. Illustratively, each of the fluid ejectors is oriented such that the spray vector associated therewith has (i) a non-zero vertical component of spatial extension directed perpendicularly to, and downwardly toward, the liquid-surface plane and (ii) a non-zero horizontal component of spatial extension directed (a) parallel to the liquid-surface plane and (b) inwardly of the depletion-zone perimeter, and toward the depletion-zone center region, so as to constrain within the foam-depletion zone, by action of the spray patterns collectively emanating from the fluid ejectors, foam situated within the foam-depletion zone for sustained impingement by the spray patterns. In other words, in more layman-like parlance, the general idea is to circumscribe foam within the foam-depletion zone with fluid ejectors such that the spray patterns emanating therefrom mutually cooperate to bombard the foam from opposing sides thereof and “trap” it within the foam-depletion zone by the action of equal and opposite spray forces so that it is subjected to continuous subsidence by the spray patterns.

As previously indicated, various implementations of the method aspect involving the containment and depletion of foam within a foam-depletion zone may be employed in conjunction with the methods of U.S. Pat. No. 9,713,779 in which the foam is intentionally moved with a non-zero net velocity relative to the underlying industrial-process liquid. Accordingly, the entirety of the detailed description of the 779 patent is actually included in the detailed description below, as are all of the drawings (FIGS. 1-7) of the 779 patent. So as not to disrupt the flow of the previous description and its references to FIGS. 1-7, the content of the previous detailed description is presented first in the following detailed description, and the original numbering of FIG. 1-7, as well as the reference characters contained therein, is also retained.

Representative embodiments are more completely described and depicted in the following detailed description and the accompanying drawings.

### BRIEF DESCRIPTION OF THE DRAWINGS

FIG. 1 is a schematic side view of tank or reservoir containing a liquid associated with an industrial process on the surface of which has accumulated a layer of foam that is being sprayed and displaced from left to right by first and second fluid-spray sources;

FIG. 2 shows two illustrative fluid-spray sources and their associated spray is patterns: (a) representing a conical spray pattern and (b) representing a “flat,” relatively planar spray pattern;

FIG. 3 is a top-down schematic view of a reservoir of liquid having a build-up of foam thereon and of a foam control system including three fluid-spray sources for subsiding and displacing the foam along a non-cyclic foam-displacement path and into a drain that is in fluid communication with the reservoir;

FIG. 4 is a top-down schematic view of a reservoir of liquid having a build-up of foam thereon and of a foam control system including four fluid-spray sources for subsiding and displacing the foam along a non-cyclic foam-displacement path and into a drain that is in fluid communication with the reservoir;

FIG. 5 is a top-down schematic view of a foam control system implemented in association with a potato processing facility that includes a potato washing drum partially immersed in a reservoir of water defined by an industrial wash table;

FIG. 6 is a top-down schematic view of a foam control method employing a cyclic foam-displacement path;

FIG. 7 is a side-view schematic depicting a foam control system including fluid-spray sources directed in opposition to a foam-displacement direction;

FIG. 8 shows a top view of a foam abatement system; and

FIG. 9 is regarded primarily as cross-sectional side view of the foam abatement system of FIG. 8, but is also discussed in the context of alternative configurations.

### DETAILED DESCRIPTION

The following description of variously configured and implemented foam control and foam abatement systems and methods is demonstrative in nature and is not intended to limit the invention or its application of uses. Accordingly, the various implementations, aspects, versions and embodiments described in the summary and detailed description are in the nature of non-limiting examples falling within the scope of the appended claims and do not serve to restrict the maximum scope of the claims.

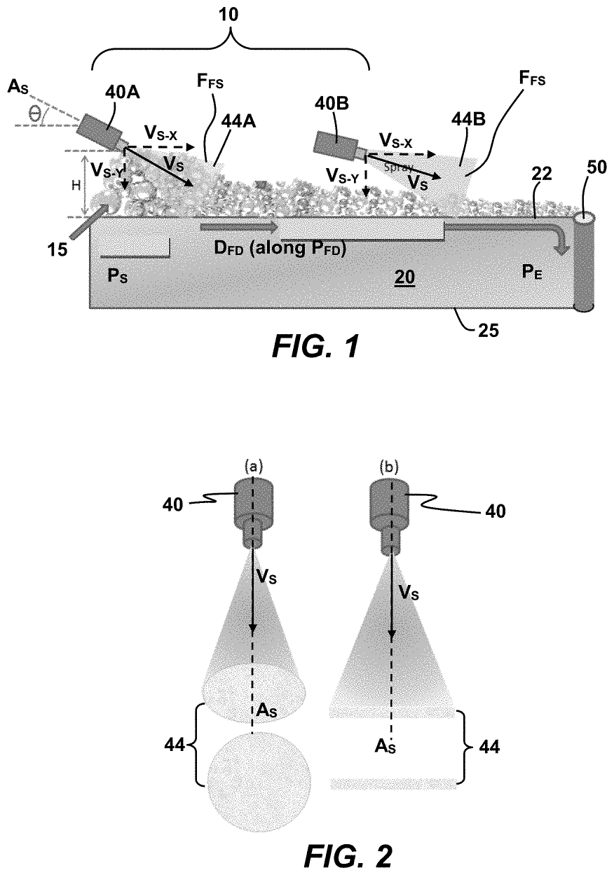

Shown in FIGS. 1-6 are various aspects of a foam control system 10 for subsiding and displacing foam 15 resulting from an industrial process and accumulating on an upper surface 22 of a liquid 20 associated with that industrial process. For ease of reference and brevity, the liquid 20 associated with the industrial process is alternatively referred to, interchangeably, as “industrial-process liquid 20,” with the same reference character 20 being used in association with either textual descriptor for the liquid 20.

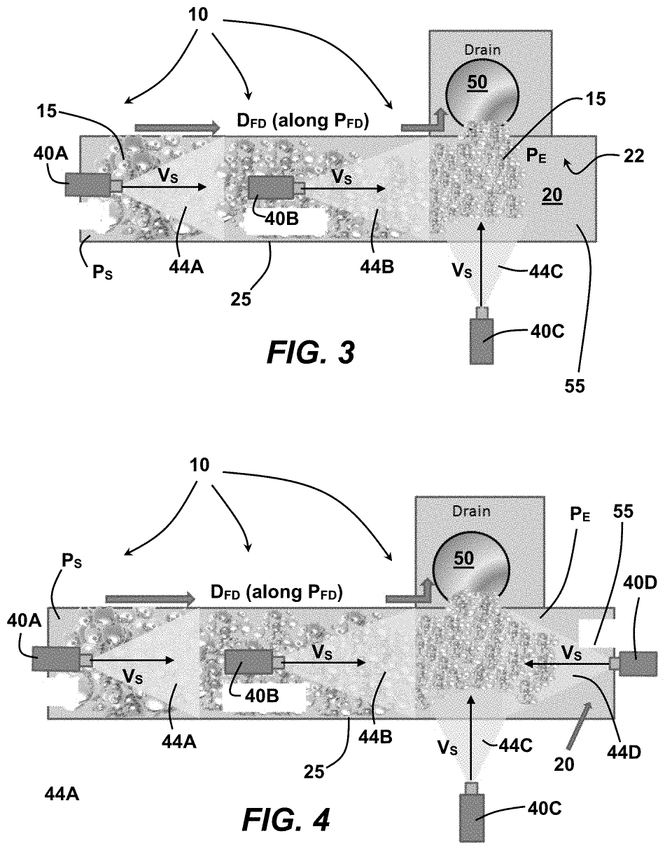

In order to provide an illustrative context and environment in association with which variations of the system 10 may be employed, alternative implementations are described with principal reference to FIGS. 1, 3, 4, and 5, in each of which there is depicted a tank or reservoir 25 for containing the industrial-process liquid 20 As indicated in the summary, the relevant industrial-process liquid 20 may comprise water. In FIG. 1, a schematic side view of an illustrative processing environment is depicted, while FIGS. 3, 4 and 5 provide top-down schematic views of alternatively configured processing environments.

As illustrated in each of FIGS. 1 and 3-5, implementations of the foam control system 10 and associated method require establishment of a foam-displacement path P_{FD} along which foam 15 resulting from a relevant industrial process is to be displaced. Also established is a foam-displacement direction D_{FD} along the foam-displacement path P_{FD} in which resultant foam 15 is to be displaced as the foam 15 accumulates on the surface 22 of the industrial-process liquid 20. Both the foam-displacement path P_{FD} and the path direction D_{P} are indicated by arrows within the relevant drawings. Referring still to FIGS. 1 and 3-5, a set of fluid-spray sources 40 is provided that includes at least first and second fluid-spray sources 40A and 40B, but can include additional fluid-spray sources 40C, 40D, 40E, etc. In each of the drawings, the fluid-spray sources are denoted by reference characters including the same numeric element “40,” but are distinguished from each other in that each is denoted, within each drawing, is by a distinct alphabetic element (e.g., “A,” “B,” “C,” etc.). Moreover, when the fluid-spray sources 40 are referred to collectively, or there is otherwise no need to refer to any of them in particular, only the “base” numeric element is used. Moreover, elements of other aspects of the system 10, such as spray patterns 44, are numbered using a similar alphanumeric convention as indicated.

The fluid-spray sources 40 are serially arranged above the surface 22 of the industrial-process liquid 20. Each fluid-spray source 40 as the capacity to selectively eject under pressure a foam-subsiding fluid F_{FS}. Moreover, each fluid-spray source 40 is configured such that foam-subsiding fluid F_{FS} ejected therefrom is sprayed in a spray pattern 44 that is centered about a spray axis A_{S}. Illustrative spray patterns 44 are shown in FIG. 2 and discussed below.

Regardless of its general configuration (e.g., planar or conical), each spray pattern 44 is representable by a spray vector V_{S} extending along the spray axis A_{S} about which that spray pattern 44 is centered. As depicted most clearly in the example represented by the schematic side view of FIG. 1, each fluid-spray source 40 is oriented such that its associated spray vector V_{S} has (i) a non-zero component of spatial extension directed perpendicularly to, and downwardly toward, the industrial-process liquid and (ii) a non-zero component of spatial extension directed parallel to the surface 22 of the industrial-process liquid 20 and in the foam-displacement direction D_{FD}. In plainer terms, this simply indicates that each fluid-spray source 40 is angularly oriented such that its associated spray vector V_{S} is neither entirely perpendicular nor entirely parallel to the surface 22 of the industrial-process liquid 20.

For ease of identification and further discussion, the horizontal component of a spray vector V_{S} (i.e., the spatial-extent component of non-zero magnitude that is parallel to the surface 22 of the industrial-process liquid 20) is denoted by a dashed arrow labeled with the alphanumeric reference character V_{S-X}. In keeping with this Cartesian notation convention, the vertical component of a spray vector V_{S} (i.e., the spatial-extent component of non-zero magnitude that is perpendicular, or “orthogonal,” to the surface 22 of the industrial-process liquid 20) is denoted by a dashed arrow labeled with the is alphanumeric reference character V_{S-Y}. Of course, it will be readily appreciated that the ratio V_{S-Y}/V_{S-X} is directly related (by the trigonometric function “tangent”) to the spray-source orientation angle θ at which the spray vector V_{S} is pitched relative to horizontal. Nevertheless, the ratio V_{S-Y}/V_{S-X} itself is an important factor to conceptualize in relation to the functionality of various implementations and may vary among locations along the foam-displacement path P_{FD}. Presently, relative to various implementations, it is sufficient to observe in very general terms that, of the two spatial-extent components, the vertical component V_{S-Y} is principally responsible for subsiding foam 15, while the horizontal component V_{S-X} is principally responsible for moving the foam 15 along the surface 22 of the industrial-process liquid 20 in the foam-displacement direction D_{FD}. Accordingly, implementations of the foam control system 10 are most efficient when the ratio V_{S-Y}/V_{S-X} is optimized at each fluid-spray source 40 for both the foam-subsiding and foam-displacement factors simultaneously.

With broader reference once again to FIGS. 1 and 3-5, when an implementation of the foam control system 10 is in use, foam-subsiding fluid F_{FS} is ejected from the fluid-spray sources 40 such that foam 15 impacted by foam-subsiding fluid F_{FS} ejected from the first fluid-spray source 40A is wetted, partially subsided and displaced in the foam-displacement direction D_{FD} toward the spray being ejected from the second fluid-spray source 40B by which the foam 15 is further wetted, subsided and displaced in the foam-displacement direction D_{FD}. When three or more fluid-spray sources 40 are deployed, foam 15 initially displaced by the first fluid-spray source 40A is displaced toward, under, then through the spray pattern 44 associated with each successive fluid-spray source 40 along the foam-displacement path P_{FD}, thereby being further wetted, subsided and displaced in the foam-displacement direction D_{FD} along the foam-displacement path P_{FD}. From the aforesaid, it will be readily appreciated that the serial arrangement of the fluid-spray sources 40 defines the foam displacement path P_{FD} and that the volume of the foam 15 is reduced as the foam 15 is displaced along the foam-displacement path P_{FD}. Implementations of the foam control system 10 treat foam control in a holistic manner, rather than regarding foam control as a localized issue to be treated by selective “knock down” or chemical treatment as problematic accumulation arises. In implementations of the present system and method, foam 15 is subsided and displaced in a continuous manner along the predefined foam-displacement path P_{FD}.

As discussed in the summary, as well as above in the detailed description relative specifically to the spray-source orientation angle θ and the ratio V_{S-Y}/V_{S-X}, the reduction in the volume of foam 15 as the foam 15 is impacted and displaced by foam-subsiding fluid F_{FS} is a function of one or more alternative factors. In addition to those factors already discussed, foaming conditions of the specific industrial processing setting within which the foam control system 10 and method is implemented determines parameters for each fluid-spray source 40. In addition to the spray-source orientation angle θ, other important parameters include (i) the height H of each fluid-spray source 40 above the upper surface 22 of the industrial-process fluid 20, (iii) the configuration of the spray pattern 44, (iv) the spray droplet size, and (v) the force with which the spray impacts the foam 15 and the surface 22 of the industrial-process liquid 20. Such parameters are selected with the objective of optimizing foam-condensation efficiency and movement (flow rate) of the condensed foam 15, while minimizing the creation of additional foam 15 due to the spray impact on the surface 22 of the industrial-process liquid 20.

In various settings, minimizing the spray-source orientation angle θ works favorably for all desired effects. Lower spray-source orientation angles θ tend to increase the effective cross-sectional area of the spray pattern 44, especially for “full” spray patterns (e.g., a filled or full conical spray pattern), thus increasing the area of foam 15 that is impacted for condensation. Moreover, as the spray-source orientation angle θ is decreased, the “forward thrust” component of the spray force (i.e., along the V_{S-X} component of the spray vector V_{S}) increases, thus facilitating the movement of the condensed foam 15 along the foam-displacement path P_{FD}.

In one illustrative implementation, at least the first fluid-spray source 40A ejects a “full spray” spray pattern 44A. A non-limiting illustrative example of a “full spray” spray pattern 44 is shown in the left side portion of FIG. 2 designated as “(a).” In this particular example, the spray pattern 44 has a generally conical configuration. The spray pattern 44 is regarded as “full” because (i) its interior is occupied by jets or sprays of foam-subsiding fluid F_{FS} and/or (ii) because it not a “flat spray,” an example of which is shown in the right side portion of FIG. 2 designated as “(b).” In contrast, a “hollow” spray pattern 44 of conical configuration would include jets of foam-subsiding fluid F_{FS} only at the outside; those necessary to define the cone, while the interior would include no jets of foam-subsiding fluid F_{FS}, at least not by design. A full spray pattern 44 is a preferable choice for the first fluid-spray source 40A in various implementations because such sprays have a high cross-sectional area (dense with water jets) and, therefore, effectively cover and condense higher-volume “dry” foam 15 that manifests nearer the beginning of the foam-displacement path P_{FD}.

Referring to the right side portion of FIG. 2 designated as “(b),” a so-called “flat” spray pattern 44 is shown. Flat spray patterns 44 are more suited for implementation from fluid-spray sources 40 subsequent to the first fluid-spray source 40A. This is because foam 15 arriving toward spray patterns 44 subsequent to that issuing from the first fluid-spray source 40A has already been partially condensed and, therefore, has a reduced volume. Flatter spray patterns 44 can effectively cover the reduced-volume foam 15 and effectively displace it in the foam-displacement direction D_{FD} since their associated spray vectors V_{S} can have horizontal components V_{S-X} much greater in magnitude than their vertical components V_{S-Y}. Of course, these are provided only as edifying, illustrative examples, and local foaming conditions and structural geometries may be better suited to alternative spray types, locations, and spray-source orientation angles θ.

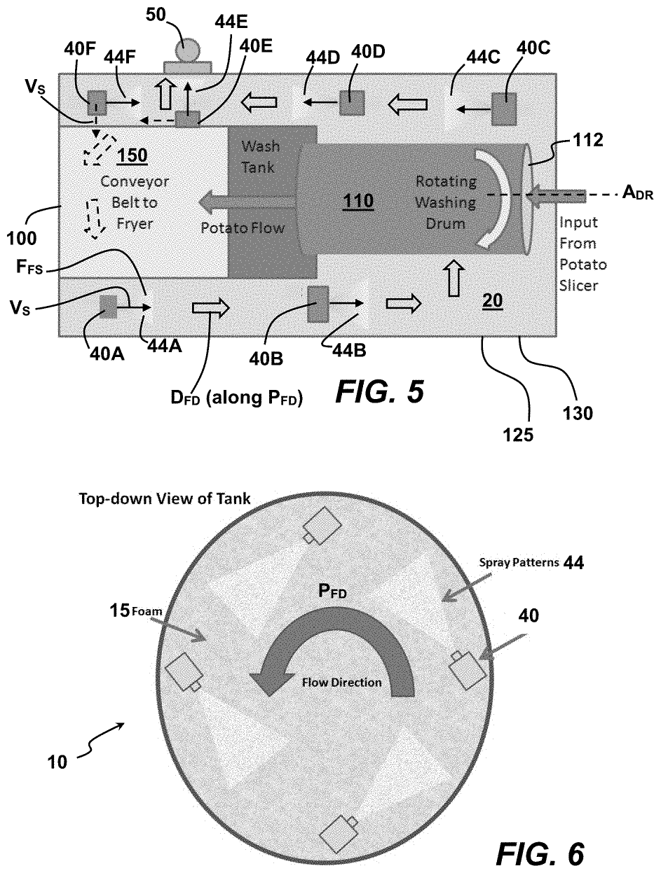

As described in the summary, alternative implementations of a chemical-free foam control system 10 employ “non-cyclic” and “cyclic” foam-displacement paths P_{FD}. Included in FIGS. 1, 3 and 4 are schematic depictions of non-cyclic foam-displacement paths P_{FD}, while FIG. 5 shows a system 10 that can be switch between cyclic and non-cyclic foam-displacement paths P_{FD}. FIG. 6 is a top-down schematic view of a reservoir 25, fluid-spray sources 40, and spray patterns 44 defining a cyclic foam-displacement path P_{FD}.

An aspect common to systems 10 implementing non-cyclic or cyclic foam-displacement paths P_{FD} is that there is a path start P_{S} corresponding to a first fluid-spray source 40A and a path end PE corresponding to a last or final fluid-spray source 40. In a non-cyclic implementation, such as those of FIGS. 1, 3 and 4, the path end PE is distinct from the path start P_{S}, and it will generally be apparent which fluid-spray source 40 is the first and which is the last along the foam-displacement path P_{FD}. In contrast, a cyclic implementation, such as that depicted in FIG. 6, is one in which foam 15 displaced to the path end PE corresponding to the last fluid-spray source 40 is further displaced by the last fluid-spray source 40 toward the path start P_{S} corresponding to the first fluid-spray source 40. Because, in a cyclic system 10, the foam-displacement path P_{FD} is essentially a “closed loop,” which fluid-spray source 40 is regarded as the first fluid-spray source 40A may be arbitrary. However, once the first fluid-spray source 40A is designated, the last fluid-spray source 40 would typically be regarded as the fluid-spray source 40 immediately “behind” the fluid-spray source 40 designated as “first” relative to the foam-displacement direction D_{FD}.

Referring again specifically to FIG. 1, a simple foam control system 10 employing only first and second fluid-spray sources 40A and 40B defining a lineal foam-displacement path P_{FD} is depicted in a side-view schematic. In this example, it can be seen that the first fluid-spray source 40A corresponding to the path start P_{S} is pitched at a fluid-spray orientation angle θ and has an associated vertical component V_{S-Y} sufficiently large for its spray-pattern 44A to wet and subside the build-up of drier and more-highly-stacked foam 15 nearest the path start P_{S}, while still having a horizontal component V_{S-X} sufficiently large to displace the partially-subsided foam toward the spray pattern 44B issuing from the second fluid-spray source 40B. The spray pattern 44B associated with the second fluid-spray source 40B further subsides the foam 15 and displaces it toward a drain 50 adjacent the path end PE, and in-line with the foam-displacement path P_{FD}. Because the foam 15 being impacted by the spray pattern 44B associated with the second fluid-spray source 40B arrives partially subsided, the spray vector V_{S} associated with the second fluid-spray source 40B has a larger horizontal component V_{S-X} and smaller vertical component V_{S-Y} than the spray vector V_{S} associated with the first fluid-spray source 40A, consistent with the discussion in preceding paragraphs addressing spray patterns 44 and spray-source orientation angles θ.

FIGS. 3 and 4 are top-down schematic views of two similar foam control systems 10 in nearly-identical industrial process settings which, like the setting in FIG. 1, include reservoirs 25 for containing industrial-process liquid 20. In each of the cases of FIGS. 3 and 4, the foam-displacement path P_{FD} defined by the fluid-spray sources 40 is both non-cyclic and non-lineal. Moreover, each includes a drain 50 for receiving industrial-process liquid 20 and any remaining, non-subsided foam 15. However, in contrast to the setting of FIG. 1, the drain 50 in each of FIGS. 3 and 4 is not “in-line” with the predominant foam-displacement path P_{FD}. More specifically, after extending in a first lineal direction—left-to-right in each of FIGS. 3 and 4—for some distance, the foam-displacement path P_{FD} is diverted to the left by a third fluid-spray source 40C that is aimed orthogonally to the previous portion of the foam-displacement path P_{FD} defined by first and second fluid-spray sources 40A and 40B. This diversion in the direction of the foam displacement path P_{FD} facilitates delivery of subsided foam 15 to the drain 50 situated to the left side of the reservoir 25.

Referring still to FIGS. 3 and 4, each reservoir 25 includes a “dead zone” 55 where foam 15 would, under normal conditions, collect and overflow the reservoir 25 in that region. This is a scenario worth addressing because such dead zones 55 are common in existing industrial process settings. To counter the build-up of foam 15 in the dead zone 55, the implementation of FIG. 4 differs from that of FIG. 3 in that the implementation of FIG. 4 further includes a fluid-spray source 40D directed outwardly from the dead zone 55 and toward the fluid-spray source 40C that directs foam 15 into the drain 50.

FIG. 5 is a top-down schematic view of a foam control system 10 implemented in association with a potato processing facility 100. While extensive detail relative to the potato processing facility 100 is not critical, some detail is warranted for purposes of providing context. The potato processing facility 100 includes a screened, rotatable potato wash drum 110 partially immersed in a reservoir 125 of industrial-process liquid 20. In this setting, the reservoir 125 is a wash tank that is part of an industrial wash table 130, and the industrial-process liquid 20 comprises water. Potato slices (not shown) are fed into the potato wash drum 110, which is partially immersed in the industrial-process liquid 20 below the drum-rotation axis A_{DR}. As the wash drum 110 rotates, the potato slices are tossed about, churned and washed by the industrial-process liquid 20 (water) in the reservoir 125. Washed potato slices then exit the wash drum 110 from which they are carried up by an inclined conveyor 150 for subsequent processing.

As with the examples of the previous schematics, the foam control system 10 employs a plurality of fluid-spray sources 40 which, in the present example, are numbered 44A thru 44F using consecutive letters of the alphabet. The system 10 depicted in FIG. 5 can be operated alternatively in a cyclic or non-cyclic fashion, depending on the selective operation and orientation of fluid-spray sources 40E and 40F.

In either a cyclic or non-noncyclic operative mode, foam 15 (omitted in this drawing for clarity) is moved along the foam-displacement path P_{FD} from the path start P_{S} near fluid-spray source 40A toward fluid-spray source 40D. In either case, the foam 15 is moved in a non-lineal way and, in this particular setting, its movement is enhanced by the rotation of the partially-immersed wash drum 110 which, when viewed from the wash-drum input end 112, rotates counter-clockwise, thereby conveying foam 15 sprayed by fluid-spray source 40B on one side of the drum-rotation axis A_{DR} toward fluid-spray source 40C located on the opposite side of the drum-rotation axis A_{DR}.

In order to operate the system 10 of FIG. 5 in a non-cyclic mode, fluid-spray source 40E is oriented so as to direct toward drain 50 foam arriving from the region of fluid-spray source 40D. In this mode, fluid-spray source 40F can either be turned off or it can be directed to spray foam-subsiding fluid F_{FS} back toward fluid-spray source 40E in much the same manner that fluid-spray source 40D is directed back toward fluid-spray source 40C in FIG. 4. Alternatively, in an illustrative cyclic operative mode, fluid-spray source 40F can be directed to spray foam-subsiding fluid F_{FS} toward fluid-spray source 40A in order to move any remaining non-subsided foam 15 under the conveyor 150 toward fluid-spray source 40A. Moreover, fluid-spray source 40E can either be turned off or directed to spray foam-subsiding fluid F_{FS} toward fluid-spray source 40F. In FIG. 5, the illustrative non-cyclic foam-displacement path P_{FD} is indicated by solid-line arrows, while the alternative cyclic foam-displacement path P_{FD} is indicated by a combination of solid-line arrows where the paths are the same and dashed-outline arrows where the cyclic path deviates from the non-cyclic foam-displacement path P_{FD}. Additionally, the spray vectors V_{S} associated with fluid-spray sources 40E and 40F for the cyclic scenario are indicated in dashed-line arrows.

FIG. 6 is a top-down schematic showing a foam control system 10 and associated method employing a cyclic foam-displacement path P_{FD}. FIG. 6 schematically represents one mode in which the foam control system 10 of FIG. 5 can operate, but such a cyclic system can also be employed outside of the processing line. For instance, foam 15 exiting a processing area through drains 50 such as those shown in FIGS. 1 and 3-5 could be channeled to a tank (not shown) in which a cyclic foam-displacement path P_{FD} is configured to further subside foam 15 after its removal from the in-line industrial-processing area, and before it is permitted to drain out into a central drainage system, such as public works. Elements of the system 10, even those not specifically discussed in this paragraph (e.g. fluid-spray sources 40), are numbered in a manner consistent with the previous numbering convention used throughout the detailed description.

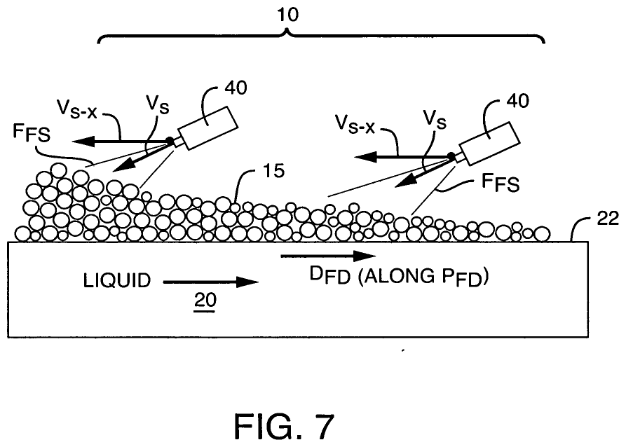

While illustrative implementations discussed above focused principally on scenarios in which the horizontal component V_{S-X} of each spray vector V_{S} is directed in the foam-displacement direction F_{FD}, there are within the scope and contemplation of the invention alternative versions in which the V_{S-X} component of each spray vector V_{S} is directed in opposition to the foam-displacement direction D_{FD}. For instance, shown in FIG. 7 is a case in which the industrial-process liquid 20 is itself being moved by a force other than that incidentally imparted by the foam-subsiding fluid F_{FS}, the moving industrial-process liquid 20 may carry the foam 15 along the foam-displacement path P_{FD} and in the foam-displacement direction D_{FD}. Such other forces might include gravity or impellors or fluid-moving jets under the surface 22 of the industrial-process liquid 20. In such cases, the serially arranged fluid-spray sources 40 still subside the foam 15 in a sequential manner, but the horizontal components V_{S-X} of their spray vectors V_{S} are not responsible for moving the foam 15 along the oppositely-directed foam-displacement direction D_{FD}. Instead, each successive fluid-spray source 40 along the foam-displacement path P_{FD} partially subsides the foam 15 which foam 15 is carried by the flowing industrial-process liquid 20 toward the next successive fluid-spray source 40 that is spraying in a direction opposed to the flow of the industrial-process liquid 20. While systems that eject foam-subsiding fluid F_{FS} in opposition to the flow of the industrial-process liquid 20 are envisioned as a special case, a setting in which such a system might be used is one in which the industrial-process liquid 20 is being drawn by gravity down an inclined flume (not shown) and the movement of the industrial-process liquid 20 is sufficiently energetic to carry with it the successively-subsiding foam 15 in opposition to the sprays of foam-subsiding fluid F_{FS} issuing from the fluid-spray sources 40.

To this point, the detailed description has addressed foam control systems 10 in which foam 15 is moved along a foam-displacement path P_{FD} with an intentional non-zero net velocity relative to the underlying industrial-process liquid 20 on which the foam 15 is accumulating and floating. Attention is now turned to the alternative, and conceptually distinct, methods in which foam is trapped and subsided by continuous impingement by sprayed foam-subsiding fluid F_{FS} within a foam-depletion zone configured to minimize the net velocity of foam 15 relative to the underlying industrial-process liquid 20. However, because it is envisioned that both system types will be used in conjunction with one another, the latter type of system is described with initial reference to a schematic in which both systems are illustrated.

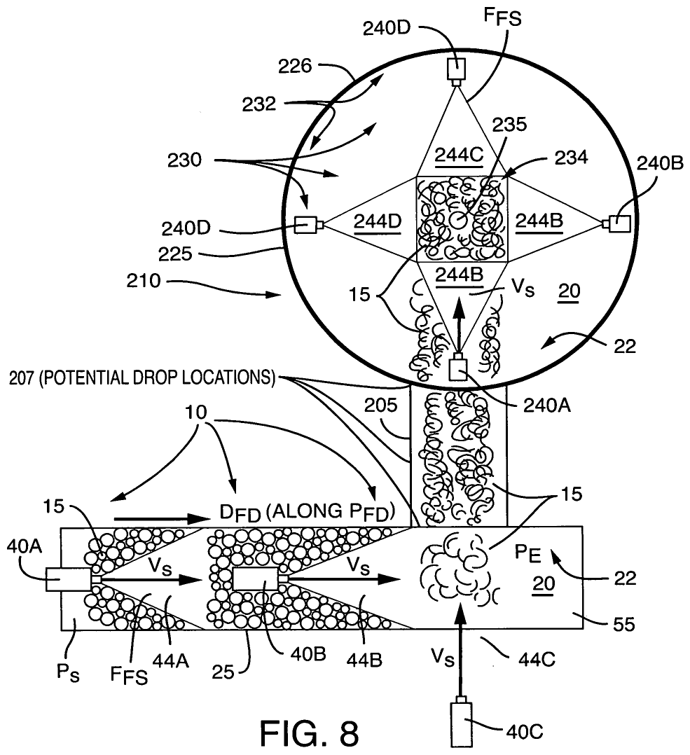

The schematic top-down view representation of FIG. 8 is very similar to that of FIG. 3. Accordingly, all of the reference numbers pertaining to the system of the 779 patent are retained and refer to the like elements, as are the reference numbers referring to environmental aspects, such as the foam 15 and the industrial-process liquid 20. Moreover, in order to facilitate conceptual clarity between the previous system and method of the 779 patent and the system and method of the present application, it is noted that in referencing components illustrative of the previous foam control system reference numbers lower than “100” were used. In connection with an illustrative environment comprising a potato washing facility 100, reference numbers in the low “100s” were used. For components illustrative of the present system, reference numbers of “200” and greater are employed. Moreover, for purposes of the differentiation in the detailed description, the system of the '779 patent is referred to as “foam control system 10,” while the present system is referred to as “foam abatement system 210.”

A principal difference between FIG. 3 and FIG. 8 is that, while in FIG. 3 residual foam 15 is being directed to a drain 50, in FIG. 8 the residual foam 15 is being directed through a connecting channel 205 to a foam abatement system 210 illustrative of the present invention. The foam abatement system 210 includes a tank or reservoir 225 for containing industrial-process liquid 20. In alternative implementations, the upper surface 22 of industrial-process liquid 20 contained by the reservoir 225 of the foam abatement system 210 may be at the same elevation as the upper surface 22 of industrial-process liquid 20 contained by the reservoir 25 of the foam control system 10. Alternatively, the upper surface 22 of industrial-process liquid 20 in the reservoir 225 may be at an elevation lower than the upper surface 22 of industrial-process liquid 20 contained by the reservoir 225, with there being a drop location 207 between the two systems 10 and 210 within and by which foam 15 and industrial-process liquid 20 cascades under the force of gravity G from reservoir 25 to reservoir 225. In one example, the connecting channel 205 may be downwardly sloped to serve as a drop location 207 and achieve the cascade, an alternative scenario indicated in FIG. 8. In other cases, there may be a stepped drop location 207 between one or both of (i) the reservoir 25 and the connecting channel 205 and (ii) the connecting channel 205 and the reservoir 225.

Regardless of any elevational disparity between the upper surface 22 of the industrial-process liquid 20 in the reservoirs 25 and 225, as residual foam 15 is delivered to the foam abatement system 210, it accumulates on the upper surface 22 of the industrial-process liquid 20 along a horizontal liquid-surface plane P_{LS} corresponding to the upper surface 22. Implementations of the method include designating a foam-depletion zone 230 within which residual foam 15 resulting from the industrial process is situated. In various implementations, the foam-depletion zone 230 has defined in association therewith a depletion-zone perimeter 232 and, inwardly of the depletion-zone perimeter 232, a depletion-zone center region 234 that, in various implementations, includes a geometric center 235 of the foam-depletion zone 230. In this particular case, the depletion-zone perimeter 232 coincides with the single tank-side wall 226 of the illustrative reservoir 225 depicted.

A set of fluid ejectors 240 is provided that, at least in their individual configurations, but not in their mutual arrangement and alignment, may generally correspond to the fluid-spray sources 40 associated with the foam control system 10. In the non-limiting illustrative case of FIG. 8, the fluid ejectors 240 include fluid ejectors 240A, 240B, 240C, and 240D. In each of the drawings, the fluid ejectors are denoted by reference characters including the same numeric element “240,” but are distinguished from each other in that each is denoted, within each drawing, by a distinct alphabetic element (e.g., “A,” “B,” “C,” etc.). Moreover, when the fluid ejectors 240 are referred to collectively, or there is otherwise no need to refer to any of them in particular, only the “base” numeric element is used. Moreover, elements of other aspects of the system 210, such as spray patterns 244, are numbered using a similar alphanumeric convention as indicated.

As with the fluid-spray sources 40, each fluid ejector 240 is configured to selectively eject a foam-subsiding fluid F_{FS} under pressure in a spray pattern 244 that is representable by a spray vector V_{S}. Moreover, the spray pattern 244 is typically centered about a spray axis A_{S} along which the spray vector V_{S} extends. The full discussion of the spray vectors V_{S} associated with the fluid-spray sources 40, and the spray patterns 44 emitted therefrom, applies with equal validity to the nature of the spray vectors V_{S} associated with the fluid ejectors 240, and the spray patterns 244, emitted therefrom. Accordingly, further discussion of same is omitted for purposes of efficiency and brevity.

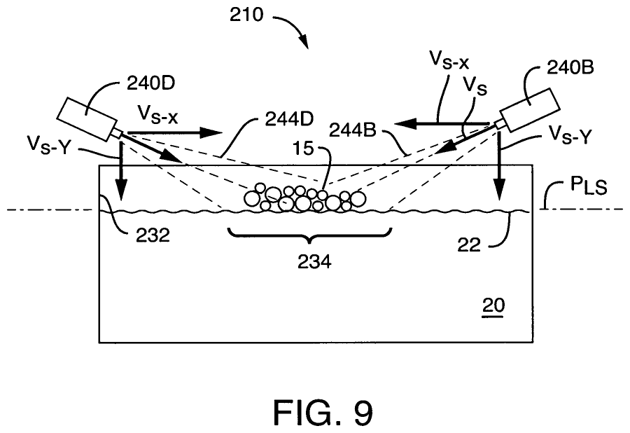

With reference to FIG. 8, as well as the cross-sectional/side view of FIG. 9 showing fluid ejectors 240B and 240D of FIG. 8, the fluid ejectors 240 are peripherally disposed above the liquid-surface plane P_{LS} and, in the case of FIG. 8, about the depletion-zone perimeter 232. In this way, the fluid ejectors 240 are at a higher elevation than residual foam 15 that is situated within the bounds of the depletion-zone perimeter 232 and on the upper surface 22 of the industrial-process liquid 20.

In addition to their peripheral disposition, and as seen perhaps best in FIG. 9, the fluid ejectors 240 are mutually arranged so that they are inwardly and downwardly directed toward the depletion-zone center region 234. Illustratively, each of the fluid ejectors 240 is oriented such that the spray vector V_{S} associated therewith has (i) a non-zero vertical component V_{S-Y} of spatial extension directed perpendicularly to, and downwardly toward, the liquid-surface plane P_{LS} and (ii) a non-zero horizontal component V_{S-X} of spatial extension directed parallel to the liquid-surface plane P_{LS}. Additionally, the non-zero horizontal component V_{S-X} of each spray vector V_{S} is directed inwardly of the depletion-zone perimeter 232 and toward the depletion-zone center region 234. By these orientations of their corresponding spray vectors V_{S}, the spray patterns 224 collectively constrain within the foam-depletion zone 230 and, more particularly, within the depletion-zone center region 234, foam 15 situated within the foam-depletion zone 230 for sustained impingement by the spray patterns 244.

In the example of FIG. 8, the foam-abatement system 210 is separately discernable from the foam control systems 10 in which foam 15 is moved along a foam-displacement path P_{FD} in the sense that the foam abatement system 210 of FIG. 8 includes a separate reservoir 225, not “in-line” with the foam control system 10 and the predominant foam-displacement path P_{FD}, defined thereby, to which residual foam 15 accumulated within the “main-line” foam control system 10 is diverted for abatement. However, it is to be understood that within the contemplation of the invention as captured within the scope of at least some of the claims, are implementations in which the foam abatement system 210 is “in-line” with a foam control system 10. For example, along the foam-displacement path P_{FD} defined by fluid-spray sources 40, there could be defined or designated one or more foam-depletion zones 230 within which residual foam 15 resulting from the industrial process is situated.

In one such arrangement, fluid ejectors 240 disposed in mutual opposition, and peripherally of the foam-displacement path P_{FD} defined by fluid-spray sources 40, eject foam-subsiding fluid F_{FS} perpendicularly to the foam-displacement path P_{FD} toward the center of the foam-displacement path P_{FD}. In such a case, the depletion-zone center region 234 would be toward the center of the foam-displacement path P_{FD}. While FIG. 9 was originally introduced as a cross-sectional/side view of FIG. 9 showing fluid ejectors 240B and 240D of FIG. 8, the arrangement presently under discussion can be explained and conceptualized with reference to FIG. 9, thereby obviating the need for a separate drawing. An “in-line” foam-depletion zone 230 can be envisioned with reference to FIG. 9 by imagining the view of FIG. 9 as a cross-sectional view taken across, for example, the reservoir 25 and foam-displacement path P_{FD} shown in FIG. 3, 4, or even 8, for example. More specifically, if FIG. 9 is envisioned as a cross-sectional view taken perpendicular to the foam-displacement path P_{FD}, with the flow direction being into or out of the drawing sheet, then fluid ejectors 240B and 240D are adequately illustrative of a foam-depletion zone 230 in-line with the predominant foam-displacement path P_{FD}, with the fluid ejectors 240 disposed in mutual opposition and peripherally of the foam-depletion zone 230. Moreover, they are ejecting spray patterns 244B and 244D depletion-zone center region 234 which, it can be readily appreciated, would be toward the center of the foam-displacement path P_{FD}.

The foregoing is considered to be illustrative of the principles of the invention. Furthermore, since modifications and changes to various aspects and implementations will occur to those skilled in the art without departing from the scope and spirit of the invention, it is to be understood that the foregoing does not limit the invention as expressed in the appended claims to the exact constructions, implementations and versions shown and described.

What is claimed is:

1. A method of subsiding foam resulting from an industrial process and accumulating on the surface of a liquid associated with that industrial process, the method comprising:
designating a foam-depletion zone to which residual foam resulting from the industrial process is directed, the foam-depletion zone having defined in association therewith a depletion-zone perimeter and, inwardly of the depletion-zone perimeter, a depletion-zone center region;
providing a set of fluid ejectors including at least first and second fluid ejectors from each of which fluid ejectors a foam-subsiding fluid can be selectively ejected under pressure in a spray pattern that is centered about a spray axis and representable by a spray vector extending along the spray axis;
arranging the first and second fluid ejectors above residual foam situated within the bounds of the depletion-zone perimeter and on the surface of the liquid associated with the industrial process; and
orienting each of the first and second fluid ejectors such that the spray vector associated therewith has (i) a non-zero vertical component of spatial extension directed perpendicularly to, and downwardly toward, the liquid associated with the industrial process and (ii) a non-zero horizontal component of spatial extension directed (a) parallel to the surface of the liquid associated with the industrial process, (b) inwardly of the depletion-zone perimeter and toward the depletion-zone center region, and (c) in opposition to the non-zero horizontal component of spatial extension associated with the other the first and second fluid ejectors.

2. A method of subsiding foam resulting from an industrial process and accumulating on the surface of an industrial-process liquid associated with that industrial process along a horizontal liquid-surface plane corresponding to the surface of the industrial-process liquid, the method comprising:
designating a foam-depletion zone within which residual foam resulting from the industrial process is situated, the foam-depletion zone having defined in association therewith a depletion-zone center region;
providing a set of fluid ejectors including a plurality of at least three fluid ejectors from each of which fluid ejectors a foam-subsiding fluid can be selectively ejected under pressure in a spray pattern representable by a spray vector;
arranging the fluid ejectors above and peripherally of residual foam situated within the foam-depletion zone and on the surface of the industrial-process liquid; and
orienting each of the fluid ejectors such that the spray vector associated therewith has (i) a non-zero vertical component of spatial extension directed perpendicularly to, and downwardly toward, the liquid-surface plane and (ii) a non-zero horizontal component of spatial extension directed (a) parallel to the liquid-surface plane and (b) inwardly toward the depletion-zone center region so as to constrain within the foam-depletion zone, by action of the spray patterns collectively emanating from the fluid ejectors, foam situated within the foam-depletion zone for sustained impingement by the spray patterns collectively emanating from the fluid ejectors.

3. The method of claim 2 wherein the residual foam resulting from the industrial process is directed to the foam-depletion zone as part of an overall foam-subsiding method further comprising:
establishing a foam-displacement direction and a predominant foam-displacement path along which foam resulting from the industrial process is to be displaced as the foam accumulates on the surface of the industrial-process liquid;
providing a set of fluid-spray sources including at least first and second fluid-spray sources from which a foam-subsiding fluid can be selectively ejected under pressure;
arranging the fluid-spray sources serially above the surface of the industrial-process liquid, and orienting each fluid-spray source, such that foam-subsiding fluid ejected from each fluid-spray source is sprayed in a spray pattern that is centered about a spray axis and representable by a spray vector extending along the spray axis and having (i) a non-zero component of spatial extension directed perpendicularly to, and downwardly toward, the liquid associated with the industrial process and (ii) a non-zero component of spatial extension directed parallel to the surface of the liquid associated with the industrial process and in the foam-displacement direction, wherein the serial arrangement of the fluid-spray sources defines the predominant foam displacement path; and
ejecting foam-subsiding fluid from the fluid-spray sources such that foam impacted by foam-subsiding fluid ejected from the first fluid-spray source is wetted, partially subsided and displaced in the foam-displacement direction toward the spray being ejected from the second fluid-spray source by which the foam is further wetted, subsided and displaced in the foam-displacement direction.

4. The method of claim 3 wherein there is defined at least one foam-depletion zone that is In-line with the predominant foam-displacement path.

5. The method of claim 4 wherein there is furthermore defined at least one foam-depletion zone separately discernable from, and not in-line with, the predominant foam-displacement path.

6. The method of claim 3 wherein there is defined at least one foam-depletion zone separately discernable from, and not in-line with, the predominant foam-displacement path.

7. A method of subsiding, and moving in at least one predetermined direction, foam resulting from an industrial process and accumulating on the surface of an industrial-process liquid associated with that industrial process, the method comprising:
establishing a foam-displacement direction and a foam-displacement path along which foam resulting from the industrial process is to be displaced as the foam accumulates on the surface of the industrial-process liquid;
providing a set of fluid-spray sources including at least first and second fluid-spray sources from which a foam-subsiding fluid can be selectively ejected under pressure;
arranging the fluid-spray sources serially above the surface of the industrial-process liquid, and orienting each fluid-spray source, such that foam-subsiding fluid ejected from each fluid-spray source is sprayed in a spray pattern that is centered about a spray axis and representable by a spray vector extending along the spray axis and having (i) a non-zero component of spatial extension directed perpendicularly to, and downwardly toward, the liquid associated with the industrial process and (ii) a non-zero component of spatial extension directed parallel to the surface of the liquid associated with the industrial process and in the foam-displacement direction, wherein the serial arrangement of the fluid-spray sources defines the foam displacement path;
ejecting foam-subsiding fluid from the fluid-spray sources such that foam impacted by foam-subsiding fluid ejected from the first fluid-spray source is wetted, partially subsided and displaced in the foam-displacement direction toward the spray being ejected from the second fluid-spray source by which the foam is further wetted, subsided and displaced in the foam displacement direction;
designating a foam-depletion zone to which residual foam resulting from the industrial process and displaced in the foam displacement direction is directed and situated, the foam-depletion zone having defined in association therewith a depletion-zone perimeter and, inwardly of the depletion-zone perimeter, a depletion-zone center region;
providing a set of fluid ejectors including at least first and second fluid ejectors from each of which fluid ejectors a foam-subsiding fluid can be selectively ejected under pressure in a spray pattern that is representable by a spray vector;
arranging the first and second fluid ejectors above residual foam situated within the bounds of the depletion-zone perimeter and on the surface of the industrial-process liquid; and
orienting each of the first and second fluid ejectors such that the spray vector associated therewith has (i) a non-zero vertical component of spatial extension directed perpendicularly to, and downwardly toward, the industrial-process liquid and (ii) a non-zero horizontal component of spatial extension directed (a) parallel to the surface of the industrial-process liquid, (b) inwardly of the depletion-zone perimeter and toward the depletion-zone center region, and (c) in opposition to the non-zero horizontal component of spatial extension associated with the other the first and second fluid ejectors.

8. The method of claim 7 wherein (i) the set of fluid ejectors comprises at least three fluid ejectors arranged peripherally about the foam-depletion zone.
